(19) United States
(12) Patent Application Publication
(10) Pub. No.: US 2007/0095863 A1
(43) Pub. Date: May 3, 2007

(54) Dispensing closure for containers

(75) Inventors: Filip Vangeel, Vilvoorde (BE); Alex James Orchard, Brussels (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/586,138

(22) Filed: Oct. 25, 2006

(30) Foreign Application Priority Data
Oct. 28, 2005 (EP) 05110132.7

(51) Int. Cl. B67D 3/00; B67D 1/16

(52) U.S. Cl. 222/519; 222/110; 222/111

(57) ABSTRACT

The present invention relates to a closure suitable for dispensing pourable product from a container. More specifically, the present invention is directed to a “twist to open” type closure operated by a twisting action.

### TECHNICAL FIELD

The present invention relates to a closure suitable for dispensing pourable product from a container. More specifically, the present invention is directed to a “twist to open” type closure operated by a twisting action.

### BACKGROUND OF THE INVENTION

Dispensing closures for containers are commonly known in the art and may be based on various opening mechanisms such as “push and turn”, “twist and turn”, “twist to open” or “push and pull”. Those closures are commonly used in combination with containers designed to contain products such as food, beverages, personal care products, pharmaceutical or cosmetic products. Typical types of dispensing closures are for example described in U.S. Pat. No. 6,202,876 (push and twist), U.S. Pat. No. 5,305,932 (snap-on), U.S. Pat. No. 2,004,015507 (push and pull) or in WO 2004/110889 (push to open). The specific type of “twist to open” closures is described for example in U.S. Pat. No. 5,305,932; EP-B1-0 378 488; WO 00/30949; EP-A1-0 417 891 and in WO 03/050033.

Although the above-types of closures will generally function satisfactorily in the applications for which they are designed, they typically only permit slow dispensing of limited amount of fluids. However, in certain circumstances, it is required to dispense the contained products much faster and in a relatively large quantity. This is typically the case in the context of liquid detergent containers. It has indeed been discovered that the users of containers equipped with the corresponding dispensing closures primarily seek for the fastest possible delivery of the contained liquid detergent into an appliance or receptacle. Most commonly used closures for containers adapted for delivering liquid detergent compositions, which are typically viscous liquids by nature, are described e.g. in EP-B1-0 109 704. Those dispensing closures typically consist of two separate parts: a spouted transition piece and a screw-type cap. Although the spouted piece allows for precise pouring of the viscous liquid into the intended receptacle, the cap is however often seen as difficult and/or too long to open and may easily get lost.

Another drawback associated with the use of the above dispensing system is that under usage, liquid detergent compositions may be spilled in the area where liquid detergent is consumed and/or on the user's hands which may lead to skin irritation or even burns. This often occurs when the above-mentioned cap is also used as a dosing means.

It is therefore an objective of the present invention to provide a dispensing closure suitable for dispensing pourable product from a container which provides fast dispensing of the contained product, which is easy-to-use, mess-free and which overcomes the above-mentioned drawbacks.

It has now been found that the above objective can be met by providing a dispensing closure 1 according to the present invention.

Advantageously, the dispensing closure 1 according to the present invention exhibits improved opening/closing ergonomics. A further advantage associated with the dispensing closure 1 according to the present invention is that it provides excellent sealing vis-à-vis the contained product.

It is still another advantage that, due its particular configuration, the dispensing closure 1 of the present invention provides more convenient way of dispensing pourable product and allows better viewing of the amount of product being dispensed.

It is still a further advantage that the dispensing closure 1 of the present invention requires a minimum number of components, which greatly facilitates its manufacture and assembly, and substantially reduces the associated production costs. In addition, the dispensing closure 1 of the present invention provides a more aesthetic appeal when compared to similar closures known in the art, and contributes to provide the user with a more pleasant experience while operating domestic tasks.

Advantageously, the dispensing closure 1 according to the present invention does not require any modification of the container 2 on which it is mounted, for the dispensing closure 1 to become operable.

Other advantages and more specific properties of the dispensing closure 1 according to the present invention will be clear after reading the following description of the invention in combination with the attached drawings.

### SUMMARY OF THE INVENTION

The present invention relates to a dispensing closure 1 suitable for being mounted on a container 2, the container 2 having a dispensing opening 3 and being suitable for containing a pourable product in its interior volume, wherein the dispensing closure 1 comprises:
(a) a base member 7 comprising a means for attachment 6 to said container 2, a draining canal 12 adapted to communicate with the interior volume of the container 2, a discharging means 13 and a hollow sleeve 15; wherein the hollow sleeve 15 is adapted to communicate with the draining canal 12 and comprises a dispensing aperture 18 capable of dispensing the pourable product.
(b) a cap 19 comprising a cap top 20 and a barrel 21 extending downwardly from the cap top 20, whereby the cap top 20 is capable of covering the discharging means 13 in a tight manner vis-à-vis the content of the container 2;
(c) complementary means 27,28 of raising and lowering the cap 19 by rotation thereof, wherein the complementary means 27,28 are located in the barrel 21 and the hollow sleeve 15, and are adapted to switch the cap 19 from a lower position wherein said discharging means 13 is covered by the cap top 20 and the dispensing aperture 18 is obstructed by the barrel 21, and an upper position wherein the discharging means 13 is uncovered and the dispensing aperture 18 is unobstructed.

In another embodiment, the present invention is directed to a container closure assembly, comprising:
(a) a container 2 having a body portion 4 for holding container content, a lower closed end for supporting the container 2, an upper end including a means of attachment 30 thereon adapted to receive and affix a dispensing closure for containers; and
(b) a dispensing closure 1 as above-indicated, mounted on the container 2.

The present invention further encompasses a method of dispensing the content of a container 2 comprising the steps of:
(a) providing a container closure assembly as above-described, wherein the cap 19 is in its lower position;
(b) rotating the cap 19 so as to raise the cap 19 to its upper position;
(c) pouring the required amount of the container content through the discharging means 13;
(d) rotating the cap 19 so as to lower the cap 19 back towards its lower position.

### BRIEF DESCRIPTION OF THE DRAWINGS

FIG. 1 is a cross-section view of a container closure assembly according to the present invention. The assembly comprising a container 2 onto which is mounted a dispensing closure 1 according to another embodiment of the invention.

FIG. 2 is a top perspective view of a dispensing closure 1 according to the invention in its lower/closed position.

FIG. 3 is a top perspective view of a dispensing closure 1 according to the invention in its upper/open position.

FIG. 4 is a bottom perspective view of the cap 19 for use in a dispensing closure 1 according to the invention.

FIG. 5 is a top perspective view of the base member 7 for use in a dispensing closure 1 according to the invention.

FIG. 6 is a top view of a dispensing closure 1 according to the invention in its lower/closed position.

FIG. 7 is a top view of a dispensing closure 1 according to the invention in its upper/open position.

FIG. 8 is a side view of a dispensing closure 1 according to the invention in its lower/closed position.

FIG. 9 is a side view of a dispensing closure 1 according to the invention in its upper/open position.

FIG. 10 is a cross-sectional side view of a dispensing closure 1 according to the invention in its lower/closed position.

FIG. 11 is a cross-sectional side view of a dispensing closure 1 according to the invention in its upper/open position.

### DETAILED DESCRIPTION OF THE INVENTION

For the purposes of promoting and understanding the principles of the present invention, reference will be made to the embodiment illustrated in the drawings and specific language will be used to describe the same. While this invention is susceptible of embodiments in many different forms, this specification and the accompanying drawings discloses specific forms as examples of the invention. However, the invention is not intended to be limited to the embodiment so described.

In a first embodiment, the present invention is directed to a dispensing closure 1 suitable for being mounted onto a container 2 having a dispensing opening 3.

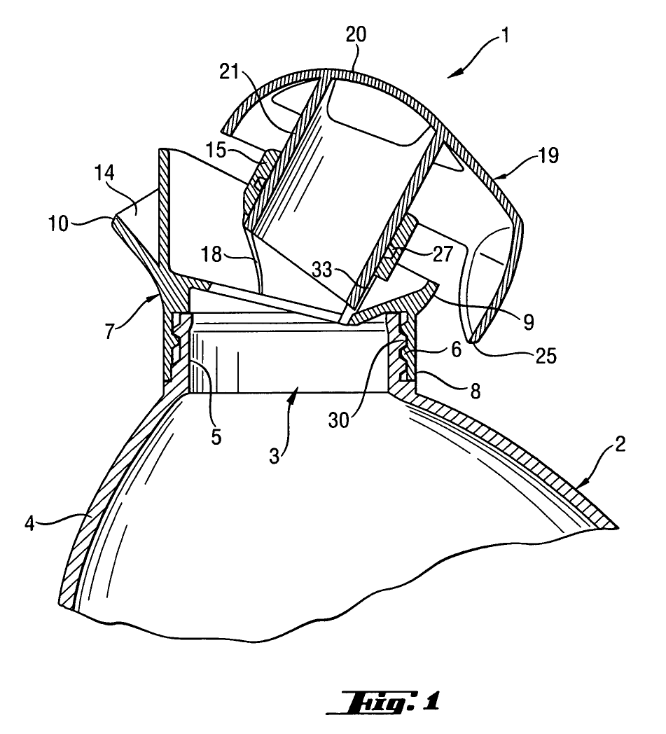

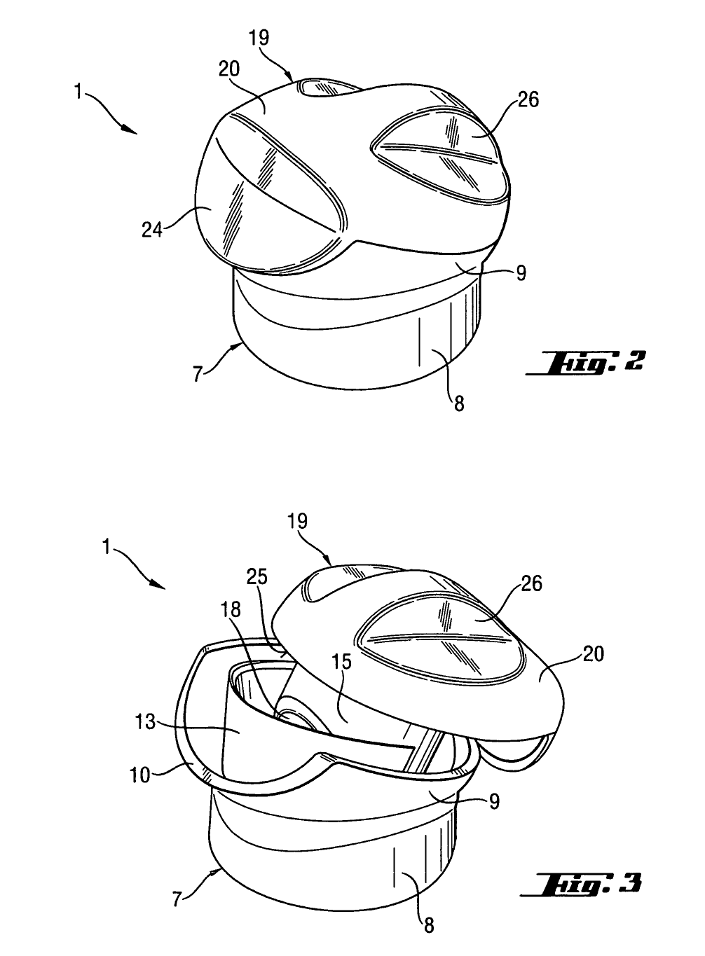

Referring now to FIG. 1, a dispensing closure 1 according to a first embodiment of the invention is represented which is mounted onto a container 2.

Container 2

In a preferred embodiment, the container 2 comprises a body portion 4 for holding container content, a lower closed end for supporting said container 2, an upper end including a neck 5 delimiting a dispensing opening 3. The dispensing closure 1 of the present invention may be securely mounted onto said container 2, via its base member 7, using any means of attachment commonly know to those skilled in the art including cooperative threads, crimping, clipping means, heat sealing force fitting, clasp elements, snap-fit bead, groove arrangements, and mixtures thereof.

Preferably, the dispensing closure 1 of the invention is provided with an inner female thread 6 typically located in the base member 7, as described hereinafter, and the container neck 5 is provided with a male thread 30 formed adjacent its dispensing opening 3. Typically, the dispensing closure 1 is mounted onto the container 2 with the female thread 6 of the base member 7 screwed on the male thread 30 of the container 2.

Alternatively, the container 2 may not need to have a neck 5. Instead the container 2 may consist of a just a body portion 4 with a dispensing opening 3. The dispensing closure 1 of the present invention is suitable for use with a variety of conventional or special containers having various designs, the details of which, although not illustrated or described, would be apparent to those skilled in the art. The container 2 may have a rigid wall or walls, or may have a somewhat flexible wall or walls.

In a preferred aspect of the invention, the dispensing closure 1 is a separate element which is adapted to be removably or non-removably mounted, via its base member 7, to a previously manufactured container 2 which has a dispensing opening 3 to the container interior. The dispensing closure 1 is adapted to be used with a container 2 having a dispensing opening 3 to provide access to the container interior volume and to a product contained therein, which is preferably a pourable product. However, the dispensing closure 1 of the invention may be used with many products, including but not limited to, relatively low or high viscosity liquids, creams, gels, suspensions, mixtures, lotions, pastes, particulates, granular products, and mixtures thereof. Typical products for use in the present invention may be those constituting a food product, a personal care product, an industrial or household cleaning product, or other compositions of matter for use in activities involving manufacturing, commercial or household maintenance, construction, agriculture.

Preferably, said pourable product is a liquid composition, more preferably a viscous liquid composition, most preferably a laundry liquid detergent composition.

Base Member 7

The dispensing closure 1 according to the present invention comprises as a first essential element, a base member 7. FIG. 5 shows is a top perspective view of the base member 7 for use in the dispensing closure 1 according to the invention.

The base member 7 is intended to be mounted onto a container 2 using any suitable means of attachment as indicated above. Suitable means of attachment are designed so as to provide secure sealing between the dispensing closure 1 and the container 2 vis-à-vis its content.

The base member 7 may have any suitable configuration, form or dimension for accommodating an upwardly projecting neck 5 or portion of a container 2. A preferred execution of the present invention, wherein the base member 7 has a substantially egg-like shape, preferably an egg-like shape, more preferably an elliptical shape, when seen from the top, as represented in the accompanying drawings.

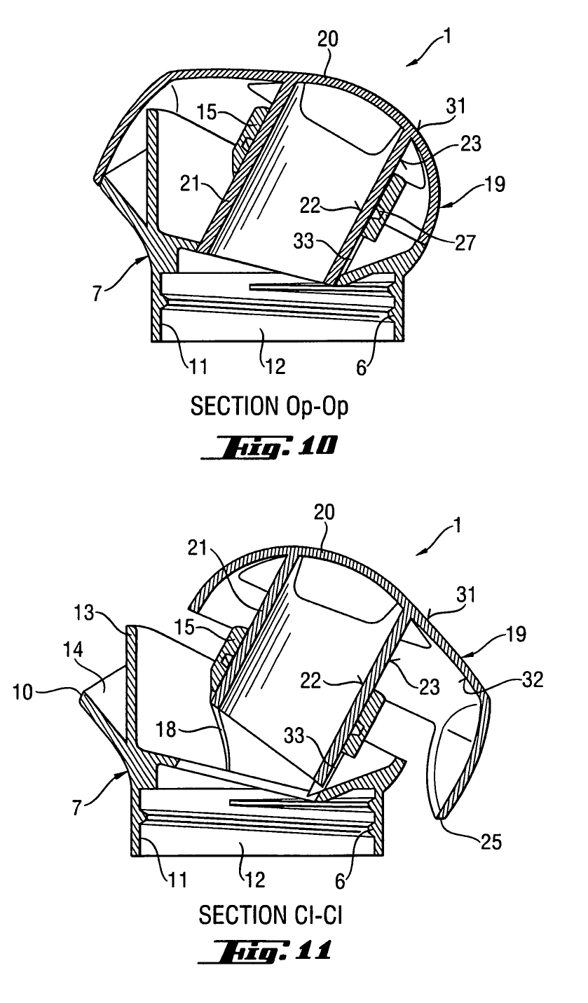

The base member 7 is comprised of two distinct parts: a skirt 8 and a platform 9. The skirt 8 generally forms the lower part of the base member 7 and extends substantially towards the container direction, typically parallel to the neck 5 of the container 2. Preferably, the skirt 8 has a substantially cylindrical shape, preferably a cylindrical shape. The platform 9, which typically extends substantially transversely to the longitudinal axis of the container 2, generally corresponds to the upper part of the base member 7. In a preferred execution of the present invention, the platform 9 has a substantially flat, plate-like shape and is provided with a platform lip 10 extending substantially over the outer perimeter of said platform 9. Platform 9 may be substantially horizontal. However, according to a highly preferred embodiment, platform 9 may be adapted such as to have an inclination of between 5 and 45 degrees, preferably between 10 and 40 degrees, more preferably between 20 and 30 degrees, most preferably between 20 and 25 degrees, above a virtual horizontal axis. As shown in FIG. 10 and FIG. 11, the means for attachment 9 is preferably located onto the inner wall 11 of the skirt 8.

Also shown in FIG. 10 and FIG. 11, the base member 7 further comprises a draining canal 12 adapted to communicate with the interior volume of the container 2 such as to permit dispensing of the container content by the discharging means 13, via the dispensing opening 3 and the dispensing aperture 18, when the cap 19 is in its upper position. Said draining canal 12 is typically delimited by the contours of said skirt 8.

Discharging means 13 for use herein may be readily recognized and selected by those skilled in the art. Preferably, said discharging means 13 is a pouring spout. In a more preferred execution, the discharging means 13 is a beveled spout which extends upwardly from said base member 7, preferably from said platform 9. Such preferred spout allows better control and more precise dispensing of the container content, especially viscous liquids such as liquid detergents. It is preferred that said discharging means 13 has a substantially annular shape.

In a further preferred embodiment of the present invention, said discharging means 13 is located in such a way as to form spacing between said discharging means 13 and the outer perimeter of said platform 9. Said spacing may preferably take the form of a circular drainer 14 adapted to recuperate any pourable product contained within the container 2, preferably viscous liquid product, which would not have been properly dispensed from said discharging means 13. Also, said spacing is preferably provided with apertures 33 communicating with the interior of the container 2 so as to permit the recuperated product to be drained back into the container 2. Additionally, said apertures 33 will also constitute air intake means adapted to allow air to penetrate into the container 2 in response to the evacuation of its content and thereby contribute to a better dispensing of the container content, preferably viscous liquids.

Referring now specifically to FIG. 5, the base member 7 further comprises a hollow sleeve 15 adapted to communicate with said draining canal 12. The hollow sleeve 15 shall be adapted so as engage the hereafter-described barrel 21 for axial motion with respect to said hollow sleeve 15. Suitable hollow sleeve 15 for use herein will be readily apparent to those skilled in the art. However, in a preferred execution, said hollow sleeve 15 has a substantially cylindrical shape, preferably a cylindrical shape, and is provided with an inner 16 and an outer surface 17. Preferably, said hollow sleeve 15 extends upwardly from said base member 7, more preferably from said platform 9, and is open at both ends.

The hollow sleeve 15 may extend substantially towards the container direction, typically parallel to the neck 5 of the container 2 and therefore towards a substantially vertical axis. In a highly preferred embodiment however, said hollow sleeve 15 may be positioned such as to have an inclination of between 5 and 45 degrees, preferably between 10 and 40 degrees, more preferably between 20 and 30 degrees, most preferably between 20 and 25 degrees, below a virtual vertical axis.

According to the present invention, said hollow sleeve 15 is provided with a dispensing aperture 18 capable of dispensing the pourable product contained into said container 2, and positioned such as to communicate with said discharging means 13.

The constituting parts of the base member 7 are formed from any suitable material commonly known in the art. Preferably, said parts are all formed from heat sealable thermoplastic materials such as polyethylene or polypropylene single piece. Accordingly, and in a preferred execution of the invention, the base member 7 is a monolithic piece formed from the same thermoplastic material. According to this specific embodiment, the different parts may be advantageously molded within a single injection molding operation which therefore involves both a simple and economical manufacturing process.

Cap 19

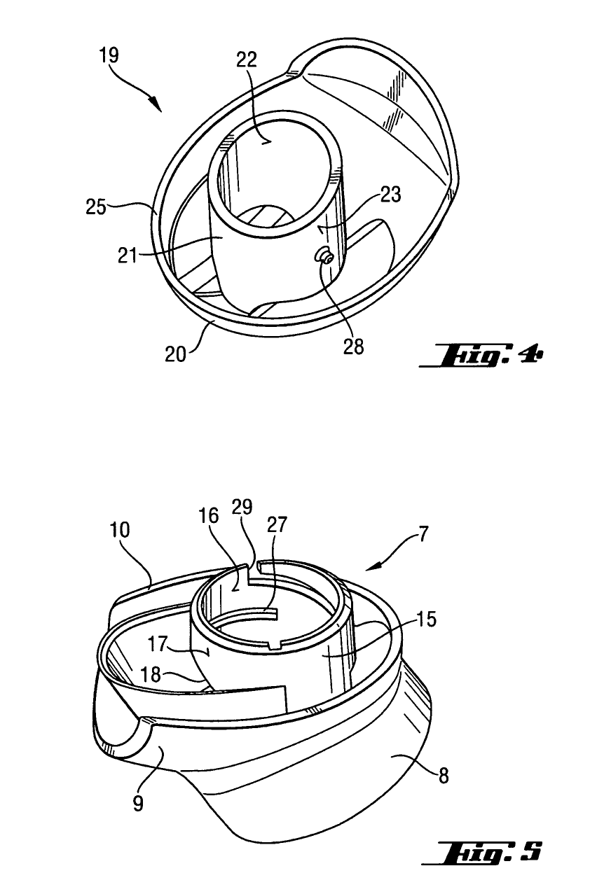

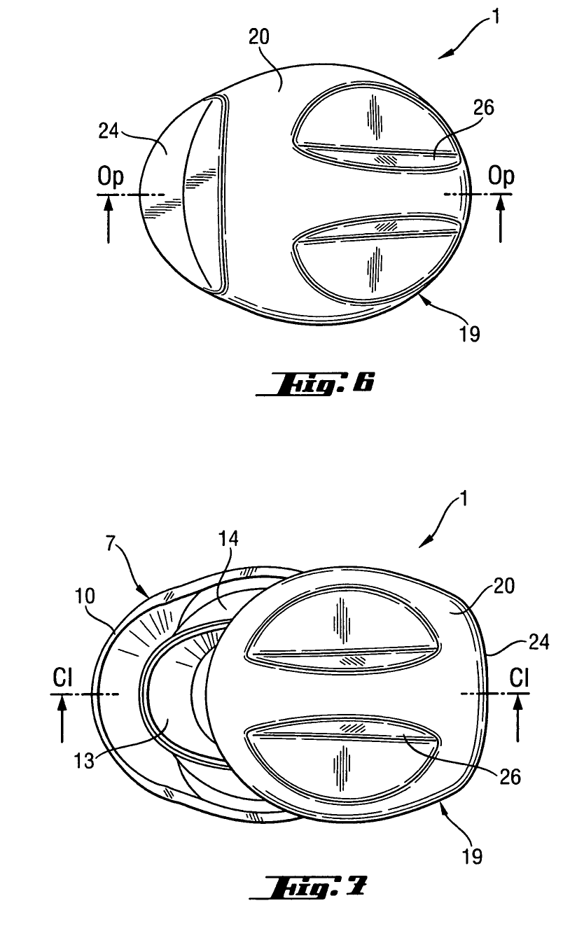

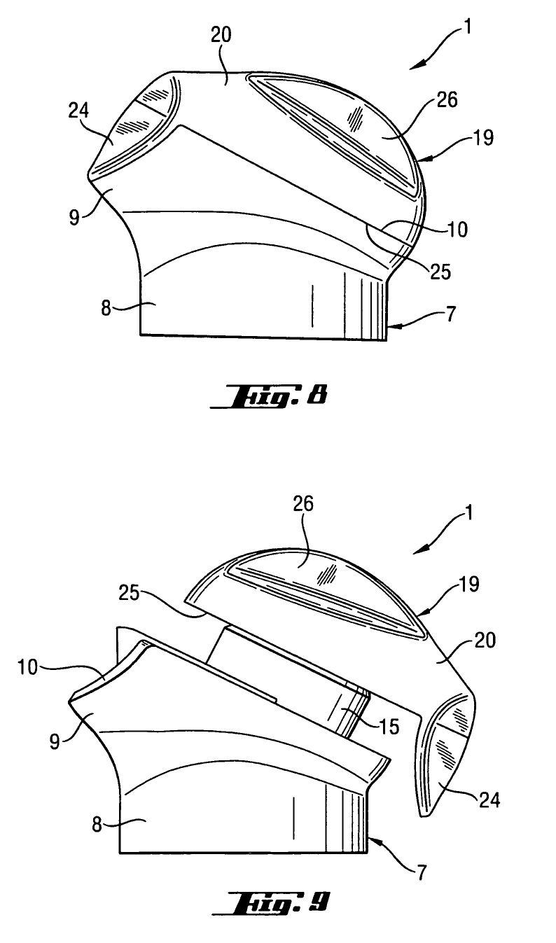

The dispensing closure 1 according to the present invention is further provided with a cap 19, the role of which is to cover the discharging means 13 in a tight manner vis-à-vis the content of the container 2 when said cap 19 is in its lower/closed position. FIG. 4 shows a bottom perspective view of said cap 19.

The cap 19 for use herein is comprised of two distinct parts: a cap top 20 and a barrel 21. The cap top 20 generally forms the upper part of the cap 19 and extends substantially transversely to the longitudinal axis of the container 2. It is typically provided with an inner face 32 and an outer surface 31.

The cap top 20 for use herein may however have any suitable configuration, form or dimension for accommodating said platform 9 and said discharging means 13. Suitable cap tops 20 for use herein will easily be recognized by those skilled in the art. In a preferred execution, the cap 19 has a substantially rounded shape which will allow proper covering of said discharging means 13. Preferably, the cap 19 has a concave form with the concavity turned towards the direction of the platform 9. More preferably, the cap top 20 is provided with a substantially egg-like shape, preferably an egg-like shape, more preferably an elliptical shape, when seen from the top, as represented in the accompanying drawings.

In a highly preferred execution of the present invention, said cap top 20 is further provided with a front screen 24 which is intended to selectively cover the extremity of said discharging means 13. Typically, said front screen 24 is located at the front part of said cap top 20.

The cap top 20 for use herein preferably possesses a cap lip 25 which is typically a substantially annular lip and which extends over the outer perimeter of said cap top 20. In that preferred embodiment, the cap lip 25 is adapted to tightly conform to the platform lip 10 contours, so as to provide a first sealing means of said cap 19 onto the base member 7 vis-à-vis the content of the container 2 when said cap 19 is in its lower/closed position.

According to a preferred aspect of the invention, the outer surface 31 of said cap top 20 is further provided with a gripping means 26, which is preferably a finger grip and which is typically located at the back part of the cap top 20. Any gripping means commonly known in the art may be used in the context of the present invention. In a very preferred embodiment, the gripping means 26 is especially adapted to provide suitable gripping by pinching with two fingers. The exterior configuration of the cap top 20 for use herein may be varied as desired for aesthetic appearance or for further improved gripping. The latter may be e.g. provided with incrustations, serrations, grooves, indentations or any other operation commonly know in the art.

As show in FIG. 4, the cap 19 is further provided with a barrel 21 which generally forms the lower part of the cap 19. Said barrel 21 typically extends substantially transversely to the plan formed by said cap top 20.

The barrel 21 for use herein may however have any suitable configuration, form or dimension for accommodating said discharging means 13 and in particular said hollow sleeve 15. Suitable barrel 21 for use herein will easily be recognized by those skilled in the art. However, in a preferred execution, said barrel 21 has a substantially cylindrical shape, preferably a cylindrical shape, and is provided with an inner 22 and an outer surface 23. Preferably, said barrel 21 extends downwardly from said cap top 20 and is open at the end (i.e. lower end) opposite to that facing said cap top 20 (i.e. upper end).

As previously mentioned, the barrel 21 is adapted so as to be engaged for axial motion with respect to said hollow sleeve 15. Accordingly, and in a highly preferred embodiment of the present invention, the outer diameter (corresponding to the outer surface 23) of said barrel 21 is slightly inferior to the inner diameter (corresponding to the inner surface 16) of said hollow sleeve 15. According to this preferred embodiment, the barrel 21 is allowed to axially slide within the interior of said hollow sleeve 15, via the hereinafter described complementary means 27,28 of raising and lowering the cap 19, while still providing efficient air tight seal (second sealing means) vis-à-vis the content of the container 2 when said barrel 21 obstructs said dispensing aperture 18.

In another highly preferred execution, the lower end of said barrel 21 is provided with a cross section which is non-perpendicular to the longitudinal axis thereof. As represented in FIG. 10 and FIG. 11, the barrel 21 for use in the present invention is preferably provided with a beveled lower end. According to this highly preferred embodiment, the dispensing aperture 18 may be unobstructed/obstructed with a limited rotation of said cap 19 and thus much faster than with the configuration where the lower end of said barrel 21 in non-beveled.

The cap 19 for use in the present invention may be formed from any suitable material commonly known in the art. Preferably, said cap 19 is formed as a single piece from heat sealable thermoplastic materials such as polyethylene or polypropylene single piece.

Complementary Means 27,28 of Raising and Lowering the Cap 19

The dispensing closure 1 according to the present invention further comprises, as another essential technical feature, complementary means 27,28 of raising and lowering said cap 19 by rotation thereof.

Complementary means 27,28 for use in the present invention are located in said barrel 21 and in said hollow sleeve 15, and are adapted for switching said cap 19 from a lower position and an upper position, by rotation of said cap 19.

Suitable complementary means 27,28 for use herein will easily be recognized by those skilled in the art. Those include but are not limited to angled or helical threads, helical grooves or notches, in combination with complementary helical threads or lugs

According to a preferred embodiment of the present invention, the complementary means 27,28 of raising and lowering said cap 19 by rotation thereof, are a cooperative combination of discontinuous helical grooves 27 and lugs 28. In a more preferred execution, and as represented in FIG. 4 and FIG. 5, said helical grooves 27 are located in said hollow sleeve 15, preferably in the inner surface 16 of said hollow sleeve 15, and said lugs 28 are positioned in said barrel 21, preferably in the outer surface 23 of said barrel 21.

In the illustrated embodiment, two such helical grooves 27 are provided at an angular increment of 180 degrees. The corresponding two lugs 28 are preferably spaced at 180 degrees increment as well. In a preferred execution, said lugs 28 have a substantially cylindrical shape, preferably a cylindrical shape, to conform to and slide within the corresponding grooves 27.

As indicated above, the complementary means 27,28 of raising and lowering said cap 19 by rotation thereof, are adapted to switch said cap 19 from a lower/closed position to an upper/open position. According to a highly preferred execution of the present invention, said complementary means 27,28 are adapted so as to allow said cap 19 to be switched from said lower position to said upper position through a limited angular displacement, preferably 180 degrees. In a very preferred embodiment, said helical grooves 27 are adapted such as angular displacement of more than 180 degrees is not permitted. This may be achieved e.g. by means of suitable rotation stops 29, as represented in FIG. 5.

In the normal course of a closing/opening operation, while said cap 19 is in its lower/closed position (see FIG. 10), the dispensing aperture 18 is obstructed by said barrel 21 and therefore seals the content of the container 2. Also, while said cap 19 is its lower position, said cap top 20 covers the discharging means 13 which provides a further sealing means for the container content and provides a visual indication that the dispensing container according to the invention is in its closed position.

While said cap 19 is being engaged in a rotational movement, said complementary means 27,28 are working in cooperation so as to progressively raise said cap 19 towards the axis of said hollow sleeve 15. As the cap 19 is rising, said dispensing aperture 18 is becoming progressively less and less obstructed until it is completely unobstructed. Concurrent to this axial motion, said cap top 20 is progressively uncovering said discharging means 13.

When said dispensing aperture 18 is completely unobstructed, the cap 19 has attained its open position, allowing the content of the container 2 to be dispensed through the discharging means 13 via said dispensing aperture 18.

In a highly preferred execution of the present invention, said complementary means 27,28 and said barrel 21 are adapted and configured so as to allow said cap 19 to be switched from the lower position to the upper position through an angular rotation of preferably 180 degrees.

In the context of the present invention, it is preferred that said complementary means 27,28 are integrally part of the specific elements they are located in. More specifically and according to a highly preferred embodiment, said helical grooves 27 are preferably integrally part of said hollow sleeve 15 and said lugs 28 are preferably integrally part of said barrel 21.

Container Closure Assembly

In another embodiment, the present invention is directed to a container closure assembly, comprising:
(a) a container 2 having a body portion 4 for holding the container content, a lower closed end for supporting the container 2, an upper end including a means of attachment thereon adapted to receive and affix a dispensing closure for containers;
(b) a dispensing closure 1 according to the invention, mounted on the container 2.
   A Method of Dispensing the Content of a Container 2

The present invention further encompasses a method of dispensing the content of a container 2 comprising the steps of:
(a) providing a container closure assembly according to the invention, wherein said cap 19 is in its lower position;
(b) rotating said cap 19 so as to raise said cap 19 to its upper position;
(c) pouring the required amount of the container content through said discharging means 13;
(d) rotating said cap 19 so as to lower said cap 19 back towards its lower position.

Use of a container closure assembly according to the invention, for dispensing a liquid composition.

In a further embodiment, the present invention is directed to the use of a closure assembly according to the present invention for dispensing a liquid composition, preferably a liquid detergent composition, most preferably a liquid laundry detergent composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dispensing closure suitable for being mounted on a container, said container having a dispensing opening and being suitable for containing a pourable product in its interior volume, wherein said dispensing closure comprises:
(a) a base member comprising a means for attachment to said container, a draining canal adapted to communicate with the interior volume of said container, a discharging means and a hollow sleeve; wherein said hollow sleeve is adapted to communicate with said draining canal and comprises a dispensing aperture capable of dispensing said pourable product.
(b) a cap comprising a cap top and a barrel extending downwardly from said cap top, whereby said cap top is capable of covering said discharging means in a tight manner vis-à-vis the content of said container;
(c) complementary means of raising and lowering said cap by rotation thereof, wherein said complementary means are located in said barrel and said hollow sleeve, and are adapted to switch said cap from a lower position wherein said discharging means is covered by said cap top and said dispensing aperture is obstructed by said barrel, and an upper position wherein said discharging means is uncovered and said dispensing aperture is unobstructed.

2. A dispensing closure according to claim 1, wherein said base member is provided with a substantially elliptical shape, when seen from the top.

3. A dispensing closure according to claim 1, wherein said means for attachment is a cooperative thread.

4. A dispensing closure (according to claim 1, wherein said base member comprises a skirt and a platform, wherein said platform has an inclination of between about 5 and about 45 degrees, above a virtual horizontal axis.

5. A dispensing closure according to claim 1, wherein said hollow sleeve has a substantially cylindrical shape.

6. A dispensing closure according to claim 1, wherein said hollow sleeve extends upwardly from said base member so as to have an inclination of between about 5 and about 45 degrees, below a virtual vertical axis.

7. A dispensing closure according to claim 1, wherein said cap top has a substantially elliptical shape, when seen from the top.

8. A dispensing closure according to claim 4, wherein said platform comprises a platform lip and said cap top comprises a cap lip conforming to said platform lip.

9. A dispensing closure according claim 1, wherein said cap top further comprises a gripping means

10. A dispensing closure according to claim 1, wherein said barrel has a substantially cylindrical shape.

11. A dispensing closure according to claim 1, wherein said hollow sleeve is capable of engaging said barrel for axial motion.

12. A dispensing closure according to claim 1, wherein the lower end of said barrel is provided with a cross section which is non-perpendicular to the longitudinal axis thereof.

13. A dispensing closure according to claim 1, wherein said complementary means of raising and lowering said cap by rotation thereof, are a cooperative combination of discontinuous helical grooves and lugs.

14. A dispensing closure according to claim 13, wherein said discontinuous helical grooves are located in said hollow sleeve, and said lugs are positioned in said barrel.

15. A dispensing closure according to claim 1, wherein said complementary means are adapted so as to allow said cap to be switched from said lower position to said upper position through a limited angular displacement.

16. A dispensing closure according to claim 1, wherein said pourable product is a liquid.

17. A container closure assembly, comprising:
(a) a container having a body portion for holding container content, a lower closed end for supporting said container, an upper end including a means of attachment thereon adapted to receive and affix a dispensing closure for containers; and
(b) a dispensing closure according to claim 1 mounted on said container.

18. A method of dispensing the content of a container comprising the steps of:
(a) providing a container closure assembly according to claim 17 wherein said cap is in its lower position;
(b) rotating said cap so as to raise said cap to its upper position;
(c) pouring the required amount of the container content through said discharging means;
(d) rotating said cap so as to lower said cap back towards its lower position.

19. Method of using a dispensing closure according to claim 1 for dispensing a liquid laundry detergent composition.
